(19) United States
(12) Patent Application Publication
(10) Pub. No.: US 2009/0110464 A1
(43) Pub. Date: Apr. 30, 2009

(54) Integrated lipstick, lip gloss, and eyebrow pencil

(76) Inventor: Jun Zhang, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,475

(22) Filed: Oct. 25, 2007

(51) Int. Cl. B05C 1/00; A47L 13/12; B43K 27/00; B43K 27/02

(52) U.S. Cl. 401/18; 401/17; 401/16; 401/19; 401/29

(57) ABSTRACT

A cosmetic tubes includes a lipstick subassembly including a front rotary drive tube having a staged member, and a rear case; a lip gloss subassembly including a removable rear extension of reduced diameter, the extension being releasably secured to the case of the lipstick subassembly; and an eyebrow pencil subassembly including a front rotary hollow cap having a front opening, and a rear positioning tube having a snapping member for releasably securing to the staged member of the drive tube of the lipstick subassembly. A person may conveniently detach any desired subassembly from the remaining subassemblies prior to use.

### BACKGROUND OF THE INVENTION

1. Field of Invention

The invention relates to tubes for cosmetic products and more particularly to a tube for containing a lipstick, a lip gloss, and an eyebrow pencil which are adapted to either join together as a unitary member for ease of carry or detach so that a woman may conveniently use a desired one of them in case of such need arising.

2. Description of Related Art

It is typical for a woman to carry a lipstick, a lip gloss, an eyebrow pencil, and other cosmetic products in her make-up kit while going out, for example, for a party. It is a burden as viewed by many women to carry so many cosmetic pieces. Thus, it is desirable to provide a cosmetic tube for containing a lipstick, a lip gloss, and an eyebrow pencil as a unit while permitting them to be detached in case of use in order to overcome the inadequacy of the prior art.

### SUMMARY OF THE INVENTION

It is therefore one object of the invention to provide a tube for containing a lipstick, a lip gloss, and an eyebrow pencil which are adapted to either join together as a unitary member for ease of carry or detach so that a woman may conveniently use a desired one of them in case of such need arising.

To achieve the above and other objects, the invention provides a cosmetic tube comprising a lipstick subassembly including a front rotary drive tube and a rear case; a lip gloss subassembly including a removable rear extension of reduced diameter, the extension being releasably secured to the case of the lipstick subassembly; and an eyebrow pencil subassembly including a front rotary hollow cap having a front opening, and a rear positioning tube releasably secured to the drive tube of the lipstick subassembly.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of cosmetic tube according to the invention;

FIG. 2 is an exploded view of the eyebrow pencil unit;

FIG. 3 is an exploded view of the lip gloss unit;

FIG. 4 is an exploded view of the lipstick unit;

FIG. 5 is a longitudinal sectional view of the assembled cosmetic tube; and

FIG. 6 is a cross-sectional view of the assembled cosmetic tube.

### DETAILED DESCRIPTION OF THE INVENTION

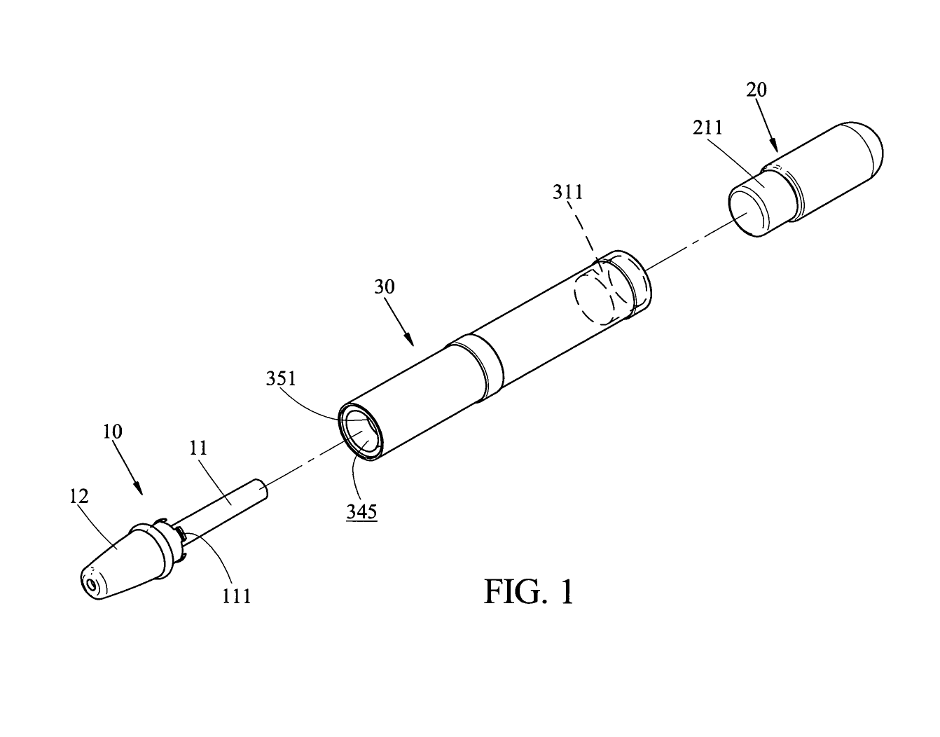

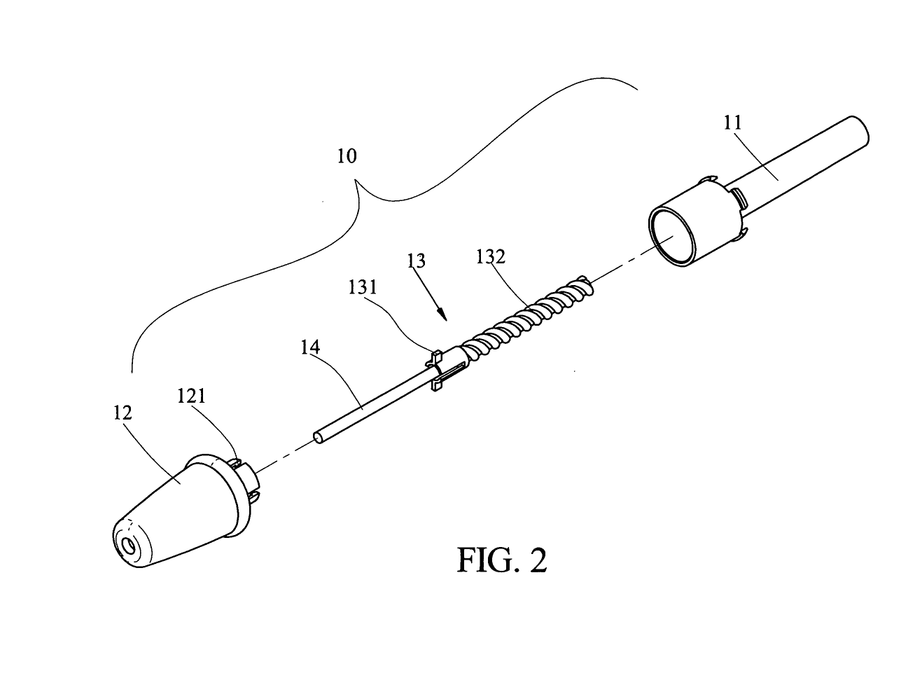

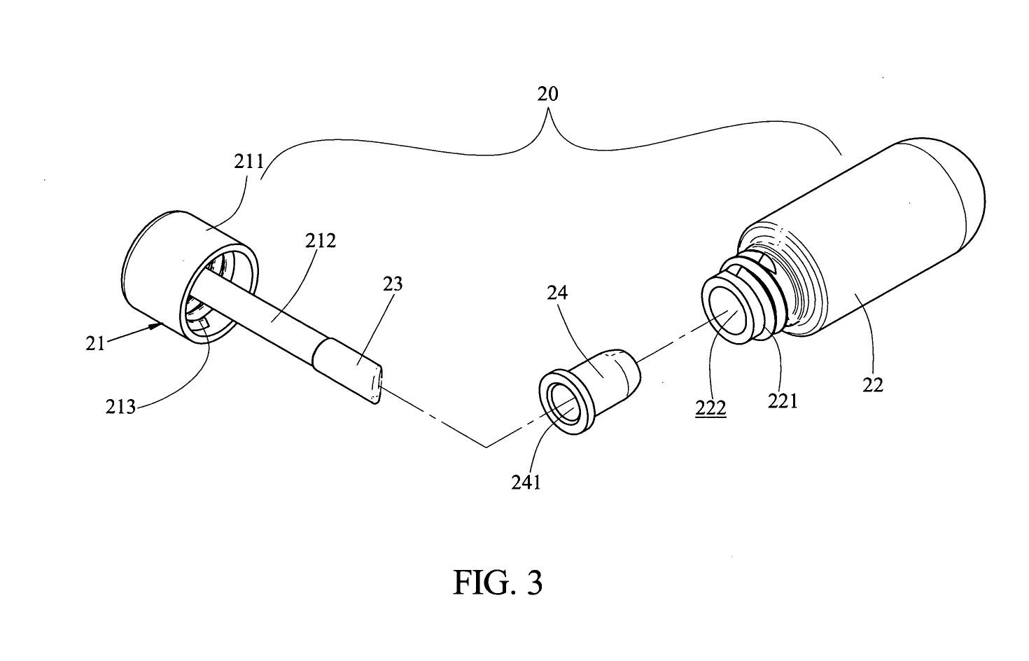

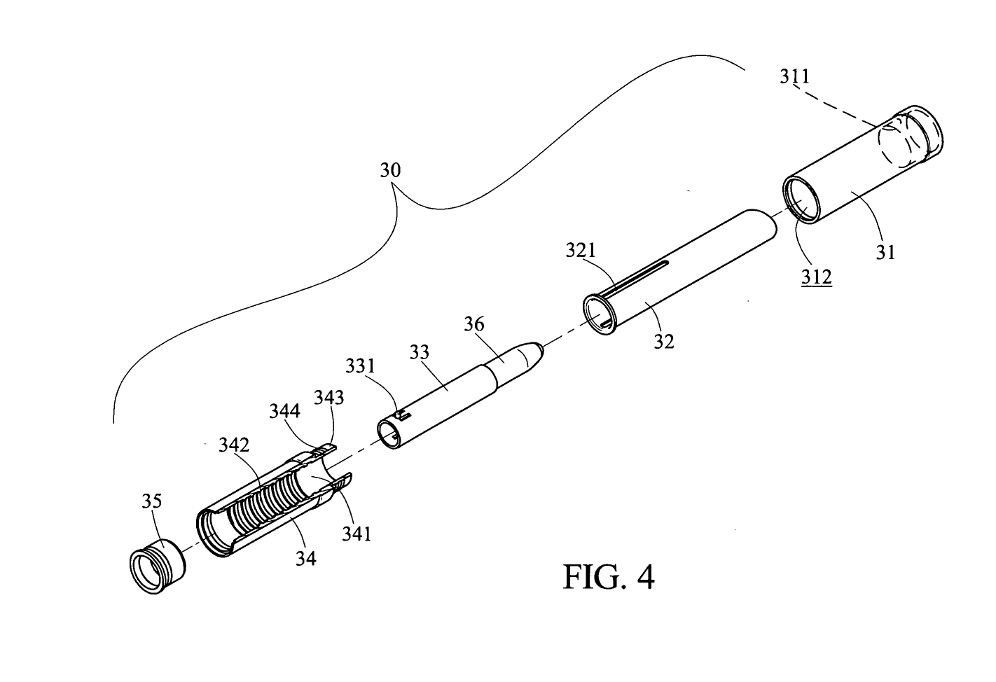

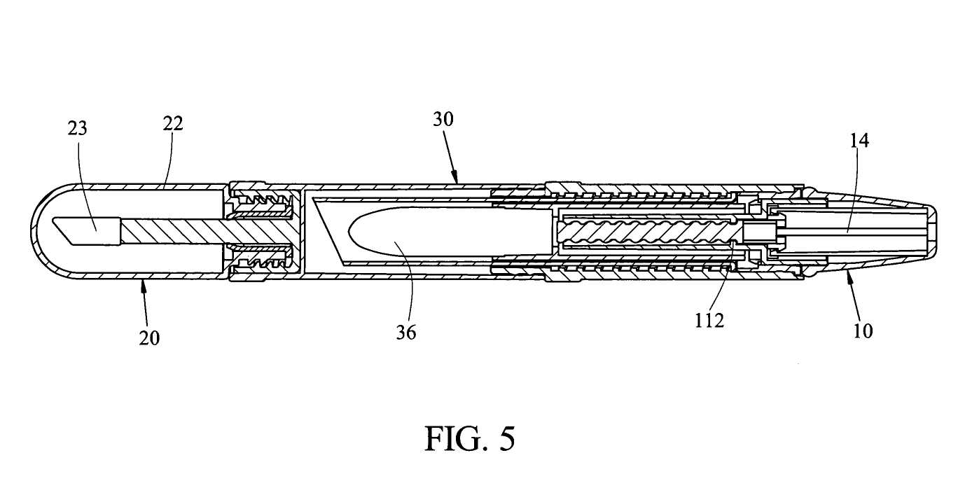

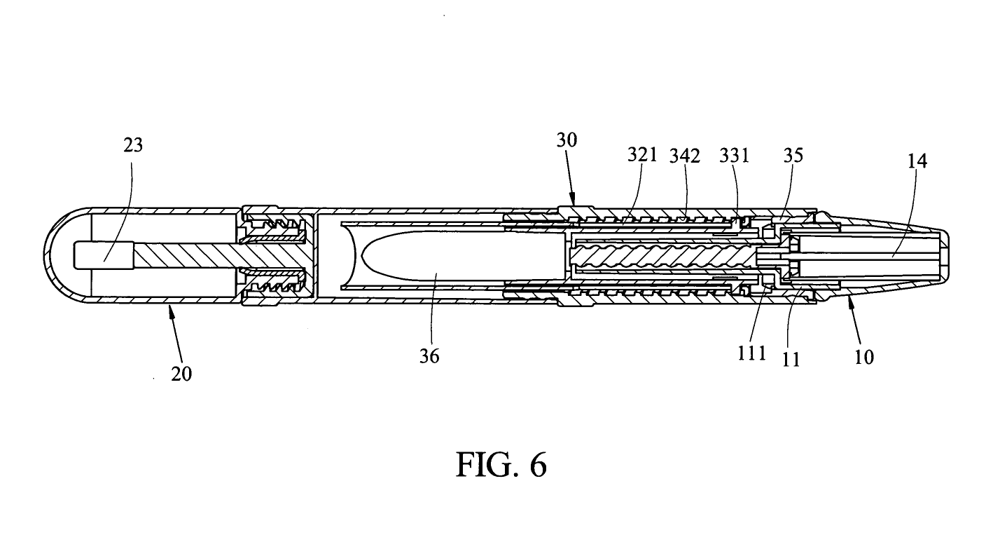

Referring to FIGS. 1 to 6, a cosmetic tube in accordance with a preferred embodiment of the invention comprises a lipstick unit 30, a lip gloss unit 20, and an eyebrow pencil unit 10. Each component is discussed in detail below.

The eyebrow pencil unit 10 comprises a front rotary cap 12 of hollow, truncated conic shape, the cap 12 including a front opening (not numbered) and two diametrically opposite grooves 121 on a rear annular extension (not numbered); a rear positioning tube 11 of open ended, the positioning tube 11 including a plurality of spaced latches 111 around a joining shoulder of the head and the main portion thereof, and two diametrically opposite lugs 112 on its cylindrical inner surface; a threaded shank 13 including two diametrically opposite tabs 131 on its enlarged head; and an elongated eyebrow pencil core 14 affixed to the head of the threaded shank 13. In an assembled state of the eyebrow pencil unit 10, the eyebrow pencil core 14 is inserted into the cap 12 to fasten therein with the tabs 131 slidably confined in the grooves 121, and a portion of the enlarged head of the positioning tube 11 is inserted into the cap 12 to fasten therein in a friction fit with the lugs 112 disposed in the spiral grooves of threads 132 of the threaded shank 13.

The cylindrical lip gloss unit 20 comprises a front cup-shaped member 21 of reduced diameter, the cup-shaped member 21 including a cylinder 211, internal threads 213 on an internal surface of the cylinder 211, and a shank 212 extending rearward from a center of a blinded end of the cylinder 211; a gloss member 23 mounted on an end of the shank 212; a tube-shaped abutment member 24 having a bore 241 through its two open ends; and a cylindrical case 22 including a front hollow, threaded extension 221 of reduced diameter and an internal space 222. In an assembled state of the lip gloss unit 20, the abutment member 24 is inserted in the threaded extension 221 and both the cylinder 211 and the gloss member 23 are inserted into the space 222 with the threads 213 threadedly secured to the threads of the threaded extension 221.

The cylindrical lipstick unit 30 comprises a front cylindrical member 35 having an annular shoulder 351 on its front edge and external threads (not numbered) adjacent the shoulder 351; a rotary drive tube 34 including rear internal threads (not numbered), a bore 341 through both open ends, internal threads 342 on a portion of an inner surface, a rear extension 343, and an externally threaded section 344 on the extension 343; a cylindrical carrier 33 having two diametrically opposite protuberances 331 proximate its front end; a lipstick 36 affixed to a rear end of the carrier 33; a cylindrical support frame 32 having two diametrically opposite slits 321 extending from a rear annular flange (not numbered) to about an intermediate portion; and a rear exterior case 31 including a front space 312 and a rear space 311 separate from the front space 312 by an internal wall (not numbered). In an assembled state of the lipstick unit 30, the cylindrical member 35 is threadedly secured to the front end of the drive tube 34, the carrier 33 is inserted into the support frame 32 with the protuberances 331 movably confined in the slits 321, the assembled carrier 33 and the support frame 32 are inserted into the drive tube 34 via its rear end with the protuberances 331 movably disposed in the spiral grooves of threads 342 of the drive tube 34, and the exterior case 31 put on the extension 343 with internal threads on an inner surface of the front space 312 being threadedly secured to the externally threaded section 344.

Moreover, the eyebrow pencil unit 10 is adapted to secure to the lipstick unit 30 by inserting the positioning tube 11 through the cylindrical member 35 into a front portion of the carrier 33 to be proximate the lipstick 36 with the latches 111 retained by the shoulder 351. Further, the lip gloss unit 20 is adapted to secure to the lipstick unit 30 by inserting the cylinder 211 of the cup-shaped member 21 into the rear space 311 of the exterior case 31 in a friction fit. This completes the assembly of the cosmetic tube of the invention.

A woman may easily carry the three-in-one tube while going out, for example, for a party. For using the eyebrow pencil unit 10, the woman may turn the cap 12 and thus the positioning tube 11 to cause the lugs 112 to turn. The turning lugs 112 thus push the threads 32 forward by moving rearward along the spiral grooves of the threads 132. As a result, the eyebrow pencil core 14 extends from the front opening of the cap 12.

For using the lip gloss unit 20, the woman may detach the cup-shaped member 21 from the exterior case 31. Next, remove the cup-shaped member 21 from the cylindrical case 22 by unscrewing the internal threads 213 from the threaded extension 221. Finally, the gloss member 23 is exposed.

For using the lipstick unit 30, the woman may detach the exterior case 31 from the drive tube 34 by unscrewing the internal threads of the exterior case 31 from the externally threaded section 344. Next, turn the drive tube 34 to extend the lipstick 36 from the rear opening of the support frame 32 by axially pushing the protuberances 331 rearward by moving the protuberances 331 along the spiral grooves of the threads 342 of the drive tube 34. Finally, the lipstick 36 is exposed.

While the invention herein disclosed has been described by means of specific embodiments, numerous modifications and variations could be made thereto by those skilled in the art without departing from the scope and spirit of the invention set forth in the claims.

What is claimed is:

1. A cosmetic tube comprising:
a lipstick subassembly including a front rotary drive tube having a front staged member, and a rear case;
a lip gloss subassembly including a removable rear extension of reduced diameter, the extension being releasably secured to the case of the lipstick subassembly; and
an eyebrow pencil subassembly including a front rotary hollow cap having a front opening, and a rear positioning tube having snapping means for releasably securing to the staged member of the drive tube of the lipstick subassembly.

2. The cosmetic tube of claim 1, wherein the cap includes a front opening, the positioning tube includes two diametrically opposite internal lugs, and the eyebrow pencil subassembly further comprises a plurality of peripheral latches adapted to secure to the drive tube of the lipstick subassembly, a threaded shank including two diametrically opposite tabs at one end with the lugs being disposed in the threads of the threaded shank, and an eyebrow pencil core affixed to one end of the threaded shank, and a rear annular projection having two diametrically opposite grooves with the tabs being slidably confined in the grooves, whereby turning the cap will extend the eyebrow pencil core from the front opening of the cap.

3. The cosmetic tube of claim 1, wherein the extension comprises internal threads and a stick extending rearward from a center of a blinded end of the extension, and the lip gloss subassembly further comprises a gloss member mounted on an end of the stick, a tube-shaped abutment member, and a casing having a front, hollow externally threaded section with the abutment member retained therein, and wherein the stick is adapted to pass the abutment member to dispose in the casing by securing the externally threaded section to the threads of the extension.

4. The cosmetic tube of claim 2, wherein the drive tube includes a cylindrical member at a front end adapted to secure to the latches, internal threads, and a rear extending section, the lipstick subassembly further comprises a cylindrical carrier including two diametrically opposite protuberances proximate its front end, a lipstick affixed to a rear end of the carrier, and a cylindrical support frame including two diametrically opposite slits, and wherein the carrier is mounted in the support frame with the protuberances movably confined in the slits, the assembled carrier and the support frame are mounted in the drive tube with the protuberances movably disposed in the threads of the drive tube, and the case and the drive tube are fastened together by securing a front end of the case to the extending section of the drive tube, whereby turning the drive tube will extend the lipstick from the support frame.

5. The cosmetic tube of claim 4, wherein the case has internal threads at a front end and the extending section of the drive tube includes external threads adapted to secure to the front threads of the case.
